(19) United States
(12) Patent Application Publication
(10) Pub. No.: US 2011/0096362 A1
(43) Pub. Date: Apr. 28, 2011

(54) Image Reading Device And Method Of Writing Image Data In An Image Reading Device

(75) Inventor: Tadayuki Okamoto, Nagano-ken (JP)

(73) Assignee: SEIKO EPSON CORPORATION, Tokyo (JP)

(21) Appl. No.: 12/883,818

(22) Filed: Sep. 16, 2010

(30) Foreign Application Priority Data
Oct. 23, 2009 (JP) 2009-244720

(51) Int. Cl. G06K 15/00

(52) U.S. Cl. 358/1.16

(57) ABSTRACT

Improving the data transfer rate of memory in an image reading device. An image reading device includes an image reading sensor that captures an image of a subject, memory that has a storage area divided into a plurality of banks, each of the plurality of banks having an image data storage area with a capacity for storing image data of the captured image, and a memory control unit that writes a portion of the image data to the image data storage area of an accessed bank and then changes the bank accessed for writing a subsequent portion of the image data so that the image data is stored in the plurality of banks segmented into data units that are smaller than the data capacity of an image data storage area.

### CROSS-REFERENCE TO RELATED APPLICATION(S)

Japanese Patent Application No. 2009-244720, filed Oct. 23, 2009, is hereby incorporated by reference in its entirety.

### BACKGROUND

1. Field of Invention

The present invention relates to an image reading device and to a method of writing image data in an image reading device.

2. Description of Related Art

Technology for image processing (such as correcting shading or gamma correction) the image data of an image scanned by a scanner, and then outputting the corrected image data to an external device such as a personal computer connected to the scanner, is known from the literature. Such scanners typically have memory, such as SDRAM (Synchronous Dynamic Random Access Memory), for storing the image data before an image data correction process is applied, and correction data used for the image data correction process. Japanese Unexamined Patent Appl. Pub. JP-A-2008-192262, for example, teaches technology related to SDRAM control.

A scanner according to the related art with SDRAM continuously writes the captured image data to the same bank of SDRAM, and reads image data from the same bank as the written bank. If an area specified by a different row address in the same bank is accessed on a time-share basis, a precharge is required with each memory access and the memory data transfer rate drops.

This problem is not limited to scanners with SDRAM, and is generally common to all types of image reading devices having memory with a plurality of banks.

### SUMMARY OF INVENTION

The present invention relates to technology that improves the data transfer rate of memory disposed in an image reading device.

Embodiments and applications of the invention that solve at least part of the foregoing problem are described below.

A first aspect of the invention is an image reading device including an image reading sensor that captures an image of a subject; memory that has a storage area divided into a plurality of banks, each of the plurality of banks having an image data storage area with a data capacity for storing image data of the captured image; and a memory control unit that writes a portion of the image data to the image data storage area of an accessed bank and then changes the bank accessed for writing a subsequent portion of the image data so that the image data is stored in the plurality of banks segmented into data units that are smaller than the data capacity of an image data storage area.

With an image reading device according to this aspect of the invention, image data can be read from a bank that is different from the bank to which image data has just been written. If data is read from a bank that is different from the bank to which data has just been written, the need for precharges can be lessened and the transfer rate of the memory in the image reading device can be improved. Furthermore, even if the bank selected for image data reading and the bank used for image data writing are the same, writing image data to and reading image data from the same bank for an extended time can be lessened because the bank accessed for writing image data changes.

In an image reading device according to another aspect of the invention, the memory control unit reads a portion of the image data from a bank that is different from the bank to which a portion of the image data has just been written.

Because the image reading device according to this aspect of the invention reads image data from a bank that is different from the bank accessed to write image data, precharges can be lessened. As a result, the data access rate of the memory in the image reading device can be improved.

In an image reading device according to another aspect of the invention, the memory control unit changes the bank accessed for writing after completing writing a particular amount of image data that is less than the data capacity of the image data storage area. The particular amount is four rows of image data in an embodiment.

The image reading device according to this aspect of the invention can store image data in each bank in a regular order.

In an image reading device according to another aspect of the invention, the memory control unit changes the bank accessed for writing according to a predetermined order. The predetermined order is sequential from a first bank to a last bank and then back to the first bank in an embodiment.

The image reading device according to this aspect of the invention can store image data in each bank in a specific order.

Another aspect of the invention is a method of writing image data in an image reading device, the image reading device having memory with a storage area divided into a plurality of banks, and each of the plurality of banks having an image data storage area with a data capacity for storing the image data, the image data writing method including: (a) capturing an image of a subject; and (b) writing a portion of the image data to the memory by accessing a bank and then changing the bank accessed for writing a subsequent portion of the image data so that the image data of the captured image is segmented into data units that are smaller than the data capacity of an image data storage area and the data units are sequentially stored in the banks.

The invention can also take other forms. For example, the invention can be utilized as a method and a device for writing image data, as an image data writing system, as an integrated circuit device that performs the function of these methods or devices, as a computer program, and as a recording medium that records the computer program.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram showing the configuration of an image reading and printing system including a hybrid device 11 according to a preferred embodiment of the invention and a personal computer 12.

FIG. 2 is an oblique view of the hybrid device 11.

FIG. 3 is a sectional view showing main parts of the hybrid device 11 and particularly the cut paper transportation path 22.

FIG. 4 is a block diagram showing the main parts of the hybrid device 11.

FIG. 5 shows the internal configuration of the memory 500.

FIG. 6 shows the process of writing image data to the first bank 510 and fifth bank 550.

FIG. 7 shows the process of writing image data to the second bank 520 and sixth bank 560.

FIG. 8 shows the process of writing image data to the third bank 530 and seventh bank 570.

FIG. 9 shows the process of writing image data to the fourth bank 540 and eighth bank 580.

FIG. 10 shows the process of writing image data to the first bank 510 and fifth bank 550.

FIG. 11 shows the process of writing image data to the second bank 520 and sixth bank 560 while image data is read from the first bank 510 and correction data is read from the fifth bank 550.

FIG. 12 shows the process of writing image data to the third bank 530 and seventh bank 570 while image data is read from the second bank 520 and correction data is read from the sixth bank 560.

FIG. 13 is a flow chart of the process that selects the bank from which correction data is read.

### DESCRIPTION OF THE PREFERRED EMBODIMENTS

### A. Embodiments

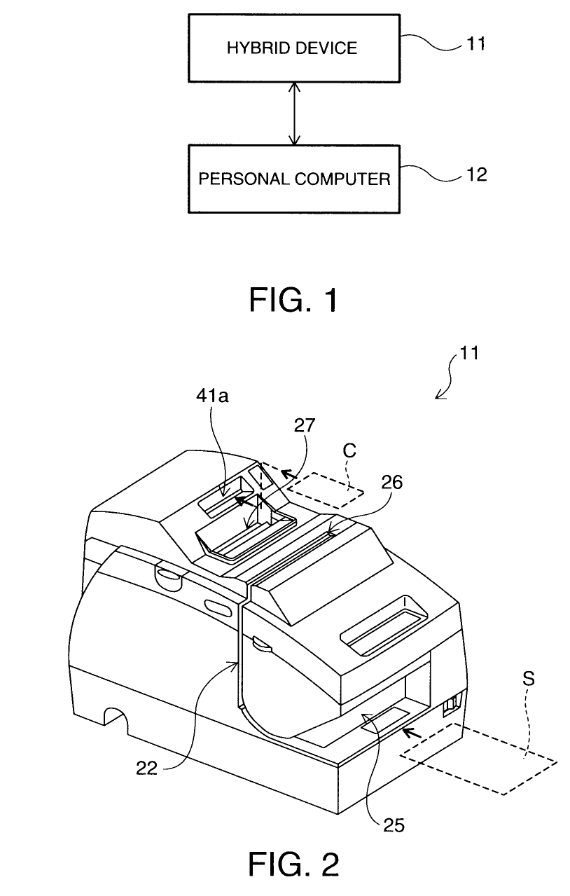

FIG. 1 is a block diagram of the configuration of an image reading and printing system according to a first embodiment of the invention.

The image reading and printing system 10 includes a hybrid scanner/printer device 11 as an image reading device (referred to below as simply a hybrid device 11), and a personal computer 12 that is connected to the hybrid device 11.

The hybrid device 11 can generate personal verification data for a check by reading both a check and an identity card or license, for example, that verifies the identity of the person presenting a check, and can print information on the check. The personal computer 12 controls operation and data processing.

FIG. 2 is an oblique view showing the outside of the hybrid device 11. The hybrid device 11 has a cut sheet insertion opening 25 from which checks or other cut sheets S are inserted, a cut sheet transportation path 22 that conveys the inserted cut sheet S, and a cut sheet exit 26 from which the conveyed cut sheet S is discharged. The hybrid device 11 also has a roll paper exit 27 from which roll paper (not shown in the figure) stored internally is discharged, and a card insertion opening 41a from which a card C used as an identity card is inserted. The hybrid device 11 also has an internal print mechanism for printing on roll paper.

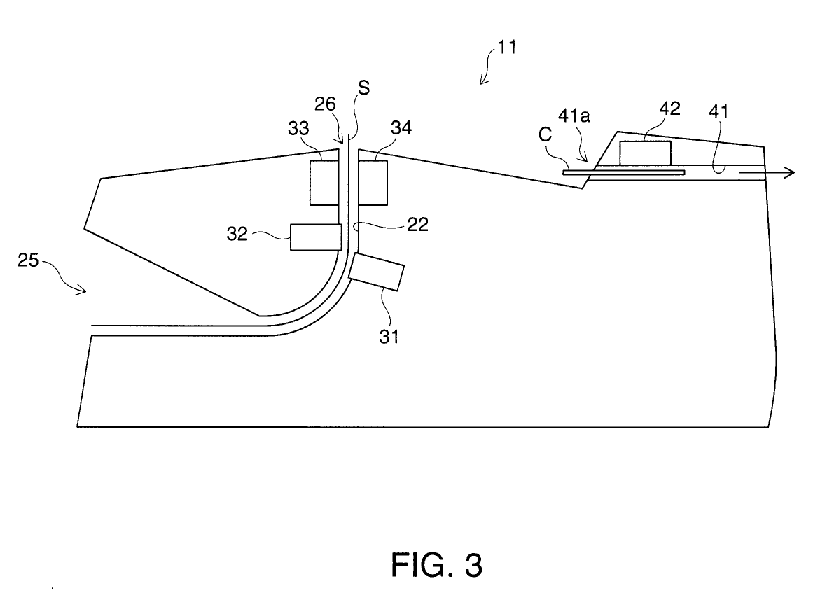

FIG. 3 is a sectional view showing the mains parts of the hybrid device 11 and particularly the cut sheet transportation path 22. A back-side printing unit 31 for printing on the back of a cut sheet S, and a front-side printing unit 32 for printing on the front of a cut sheet S, are positioned inside the cut sheet transportation path 22. The hybrid device 11 can thus print on both sides of a cut sheet S inserted from the cut sheet insertion opening 25 using the back-side printing unit 31 and front-side printing unit 32.

A first image reading sensor 33 for scanning images on the front of a cut sheet S, and a second image reading sensor 34 for scanning images on the back of a cut sheet S, are positioned near the cut sheet exit 26 of the cut sheet transportation path 22. In this embodiment of the invention the first image reading sensor 33 and second image reading sensor 34 are contact image sensor (CIS) type image scanners.

A card C inserted from the card insertion opening 41a is conveyed through the card transportation path 41 by a card transportation mechanism (not shown in the figure) using a plurality of rollers. A card image reading sensor 42 for scanning the front of a card C is positioned in or next to the card transportation path 41. Like the first image reading sensor 33 and second image reading sensor 34, the card image reading sensor 42 in this embodiment of the invention is a CIS image scanner.

The hybrid device 11 can thus scan and capture images of the front and back sides of a check inserted as a cut sheet S using the first image reading sensor 33 and second image reading sensor 34, and can read a license, identity card, or other type of card C presented by the check user using the card image reading sensor 42. The hybrid device 11 can thus easily generate check user verification data by reading a check and reading an identify card or license, for example, to verify the identity of the check user.

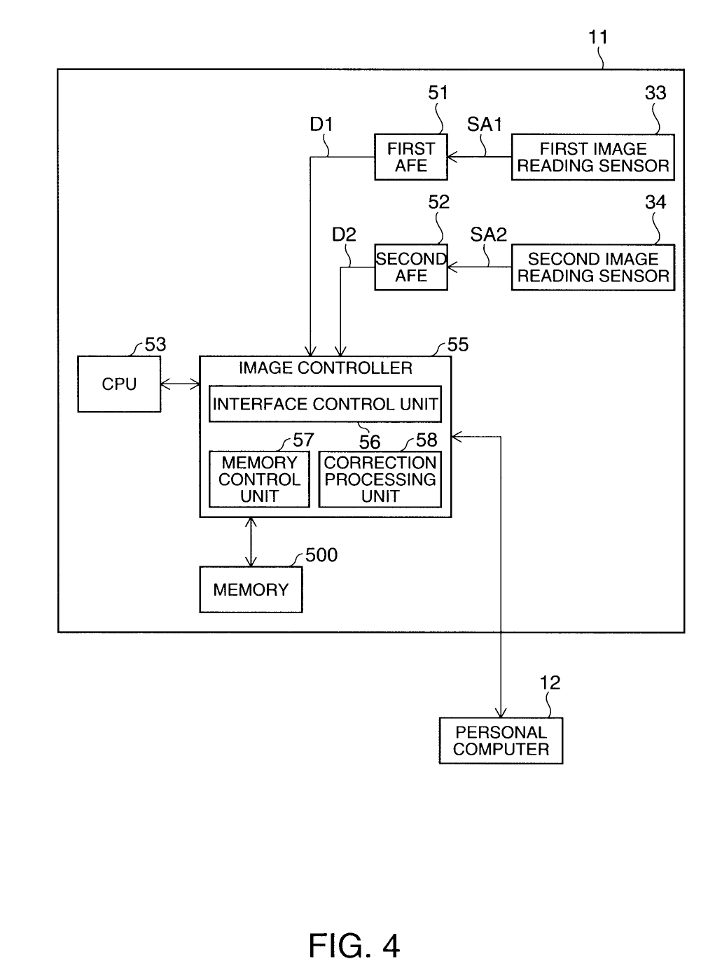

FIG. 4 is a block diagram showing the configuration of the main parts of the hybrid device 11. The hybrid device 11 has the first and second image reading sensors 33 and 34 described above, first and second analog front ends (AFE) 51 and 52, a CPU 53, memory 500, and an image controller 55 comprising, for example, a FPGA (Field Programmable Gate Array).

The first AFE 51 analog/digital (A/D) converts an input first analog read signal SA1 output from the first image reading sensor 33, and outputs the result as front image data D1. The second AFE 52 A/D converts an input second analog read signal SA2 output from the second image reading sensor 34, and outputs the result as back image data D2.

The CPU 53 controls overall operation of the hybrid device 11. As described below, the memory 500 is an SDRAM configured with eight banks, and stores the front image data D1, back image data D2, and correction data (described below).

The image controller 55 includes an interface control unit 56 that controls interface operations between other devices, a memory control unit 57 that controls writing the image data D1 and D2 to memory 500 and reading from memory 500, and a correction processing unit 58 that controls correcting the image data D1 and D2 read from the memory 500.

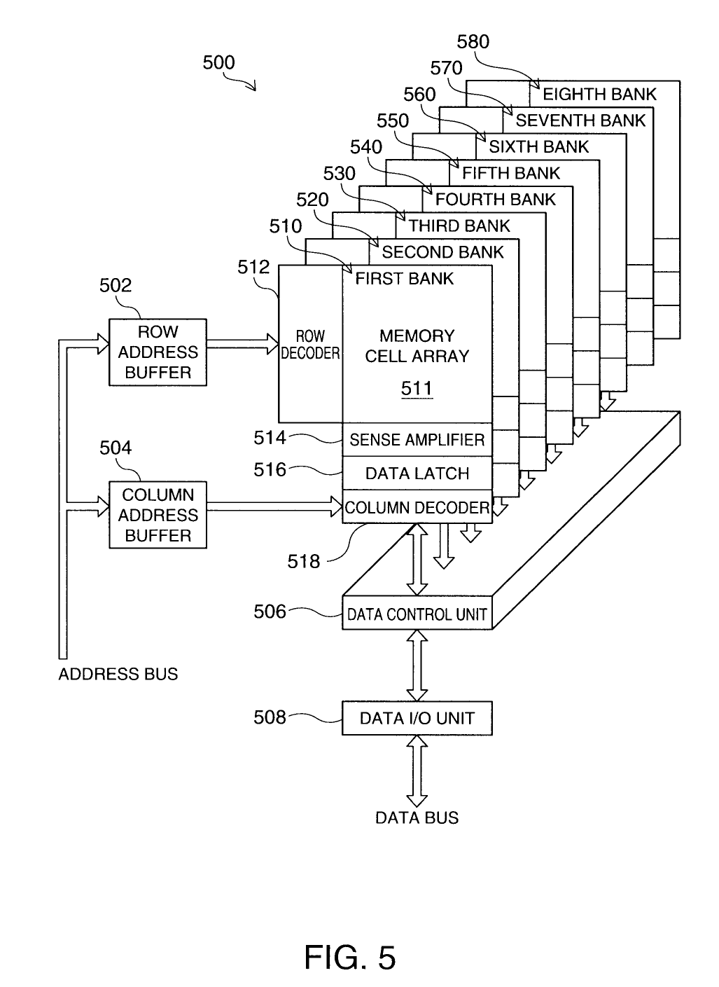

FIG. 5 shows the internal configuration of the memory 500. The memory 500 includes eight banks 510, 520, 530, 540, 550, 560, 570, 580, a row address buffer 502, a column address buffer 504, a data control unit 506, and a data I/O unit 508.

The first bank 510 includes a memory cell array 511, row decoder 512, sense amplifier 514, data latch 516, and column decoder 518. The second bank 520 to eighth bank 580 similarly include a memory cell array, row decoder, sense amplifier, data latch, and column decoder.

Of the addresses supplied from the address bus, the high 3 bits are used as a bank address, and the remaining 30 bits are used as a cell address for specifying a particular memory cell in the memory cell array. The row address composed of the high bit of the cell address is stored in the row address buffer 502. The column address composed of the low bit of the cell address is stored in the column address buffer 504. The row address stored in the row address buffer 502 is supplied to a row decoder associated with each bank. The column address stored in the column address buffer 504 is supplied to a column decoder associated with each bank.

Data stored in the area specified by the row address is amplified by the sense amplifier 514 and supplied to the data latch 516. The data control unit 506 inputs and outputs data to the column decoder associated with the bank selected by the bank address. Data is communicated between the selected bank and the image controller 55 (FIG. 4) through a data bus connected to the data I/O unit 508.

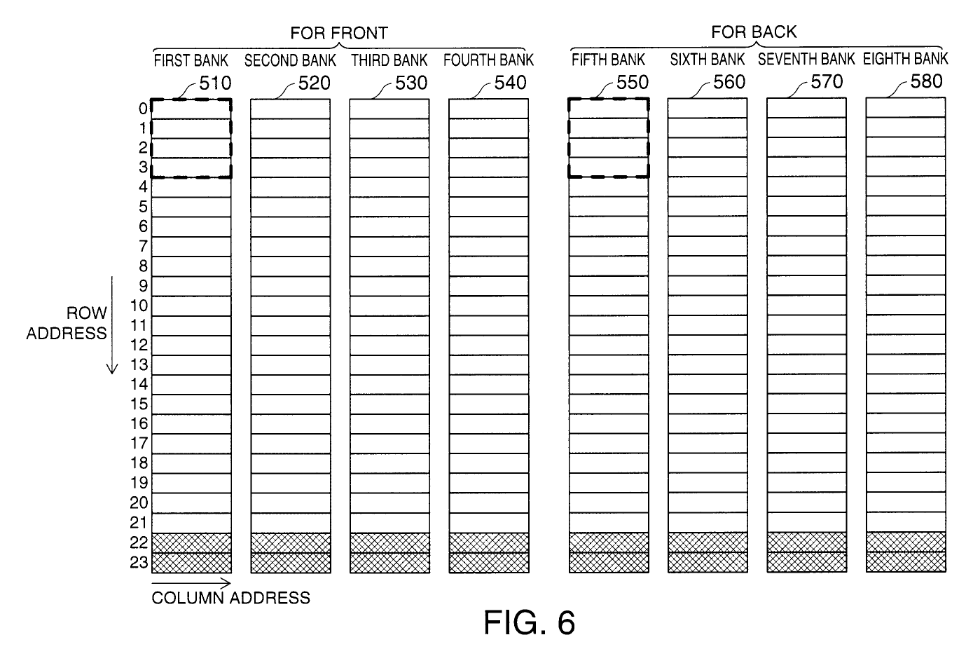

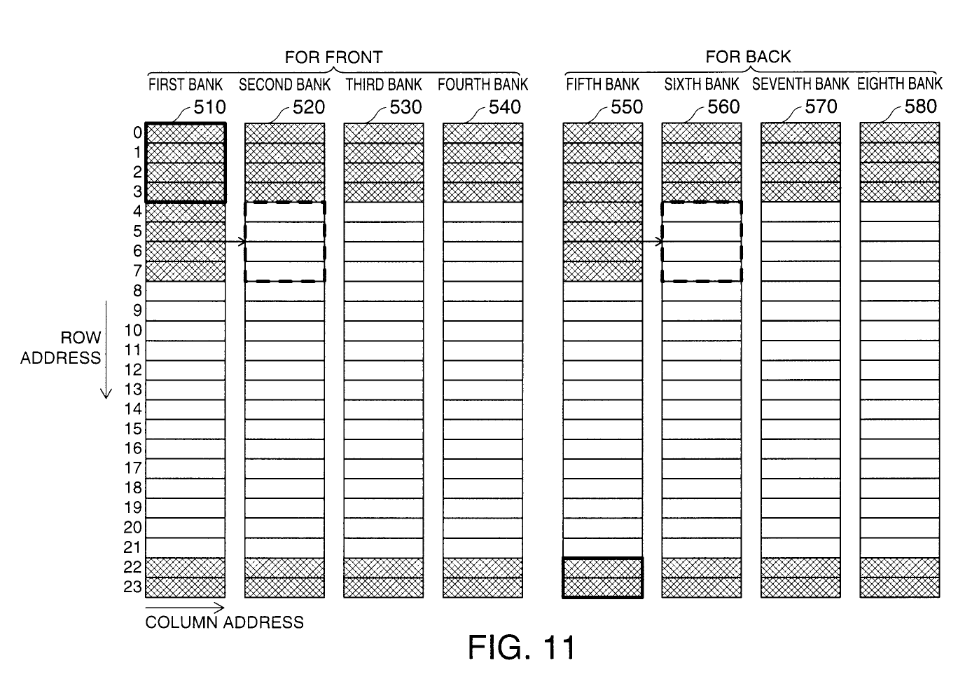

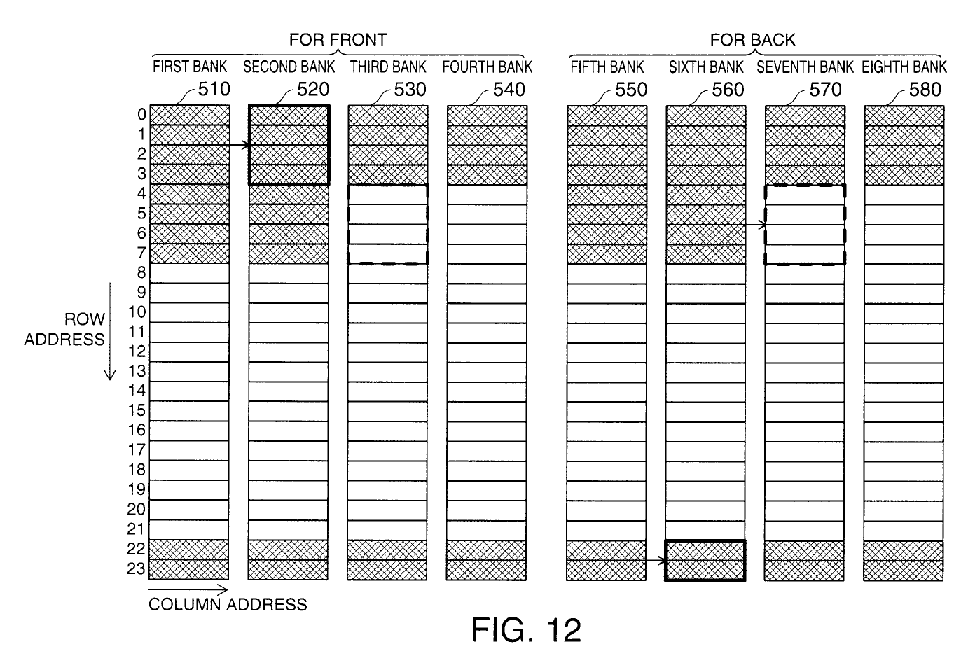

FIG. 6 to FIG. 12 illustrate the processes of writing and reading image data in the eight banks over time. Note that the cells surrounded by a bold broken line in FIG. 6 to FIG. 12 denote write cells, and cells denoted by a solid bold line in FIG. 11 and FIG. 12 denote read cells. Furthermore, while actual memory devices have storage areas denoted by many more row addresses, only storage cells denoted by row addresses #0 to #23 are shown in this embodiment for brevity. Cells with crosshatching denote cells where data is stored.

In this embodiment of the invention the memory control unit 57 of the image controller 55 uses the first bank 510, second bank 520, third bank 530, and fourth bank 540 for storing front image data D1, and uses the fifth bank 550, sixth bank 560, seventh bank 570, and eighth bank 580 for storing back image data D2. In addition, the image data storage cells used for storing image data in each bank are the cells addressed by row addresses #0 to #21.

Correction data (white reference data and black reference data) used for shading the image data D1 and D2 is previously stored in the cells addressed by row addresses #22 and #23. Shading correction is correction that is applied to remove variations in the sensitivity of individual imaging elements and variations in the amount of light from the light sources used by the image reading sensors 33 and 34.

The white reference data is acquired by each imaging element reading a standard white reference when the light source is on, and the black reference data is acquired by each imaging element reading a standard black reference when the light source is off. This correction data includes first correction data that is used to correct the shading of the front image data D1 captured by the first image reading sensor 33, and second correction data that is used to correct the shading of the back image data D2 captured by the second image reading sensor 34. Correction values for each imaging element are contained in the first correction data and second correction data. Each of the eight banks store the same first correction data and second correction data in this embodiment of the invention.

As shown in FIG. 6, the memory control unit 57 of the image controller 55 sequentially writes the front image data D1 from the area specified by row address #0 to the area addressed by row address #3 in the first bank 510, and sequentially writes the back image data D2 from the area addressed by row address #0 to the area addressed by row address #3 in the fifth bank 550. The front image data D1 and back image data D2 are written on a time shared access basis. Note that all of the following operations reading and writing memory 500 are executed using time shared access.

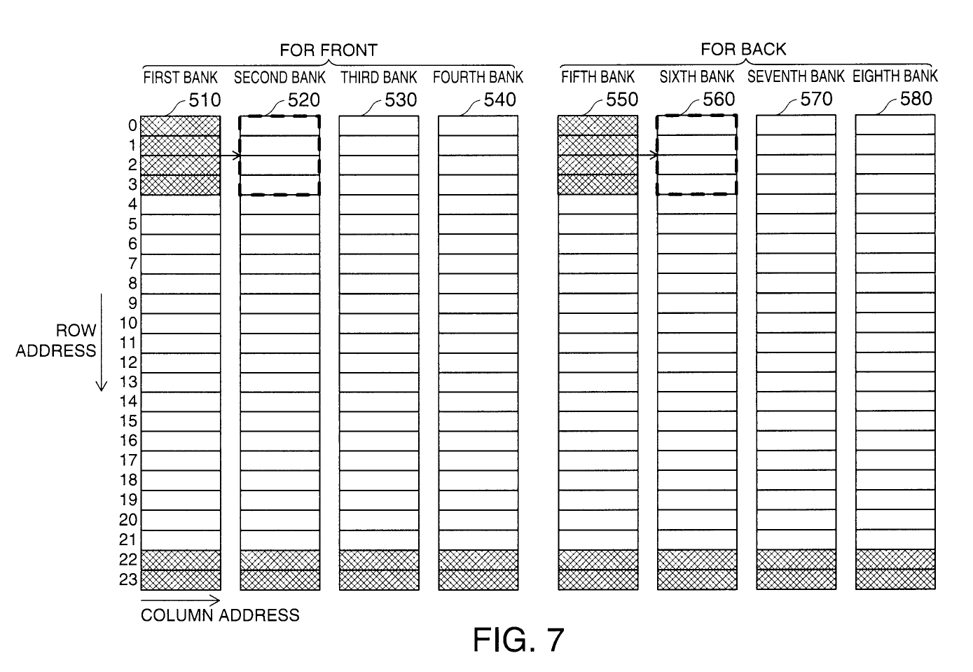

As shown in FIG. 7, when writing the front image data D1 to the cell addressed by row address #3 in first bank 510 is completed, the memory control unit 57 changes the front image data D1 write destination to the second bank 520. When writing the back image data D2 to the cell addressed by row address #3 in the fifth bank 550 is completed, the memory control unit 57 changes the back image data D2 write destination to the sixth bank 560.

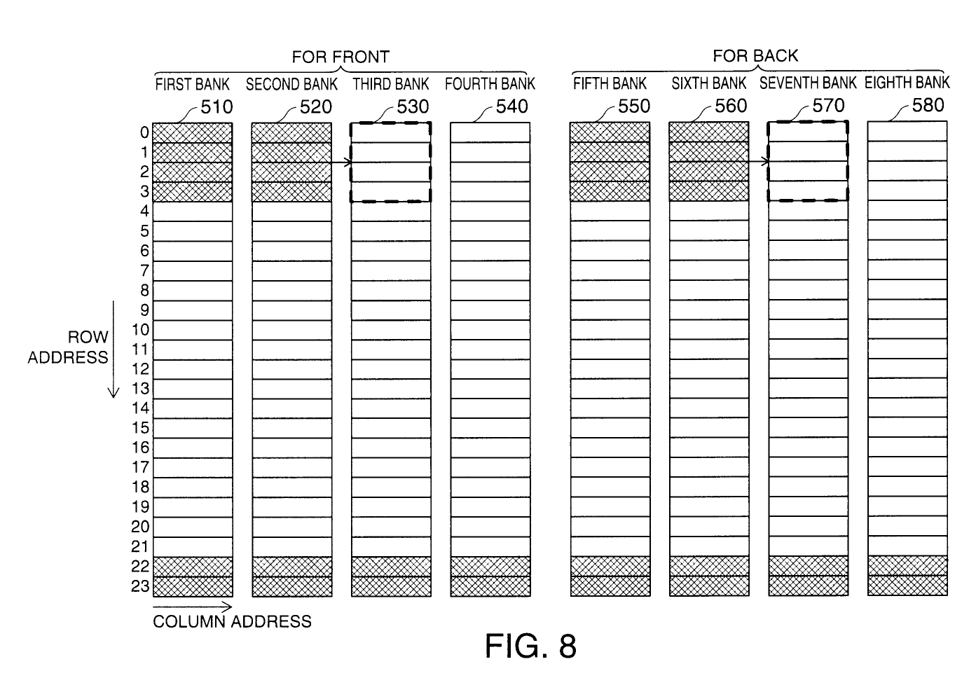

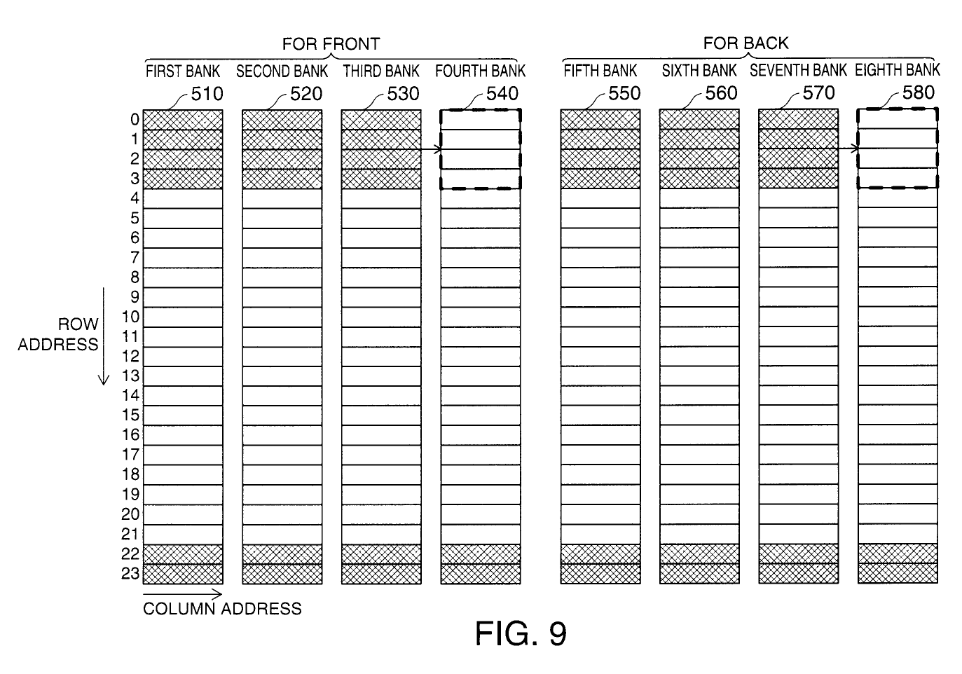

Likewise, as shown in FIG. 8 and FIG. 9, each time writing to the areas specified by the four row addresses is completed, the memory control unit 57 sequentially switches the bank that is written to the next memory bank. More specifically, the memory control unit 57 changes the bank to which image data is written so that the image data is stored in each bank segmented into data blocks (comprising a portion of the image data) that are smaller than the total storage capacity of the image data storage area of each bank.

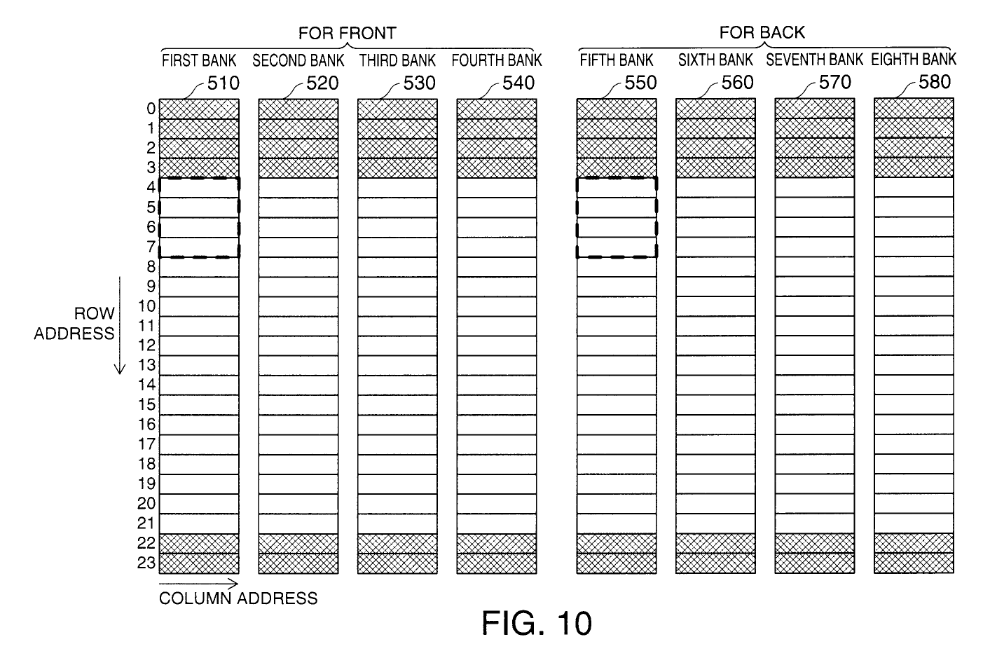

As shown in FIG. 10, when writing the front image data D1 to the area specified by row address #3 in the fourth bank 540 is completed, the memory control unit 57 changes the front image data D1 write address back to the first bank 510. When writing the back image data D2 to the area specified by row address #3 in the eighth bank 580 is completed, the memory control unit 57 similarly changes the back image data D2 write address back to the fifth bank 550.

As shown in FIG. 11, when writing the front image data D1 to the cell addressed by row address #7 in first bank 510 is completed, the memory control unit 57 changes the front image data D1 write destination to the second bank 520. When writing the back image data D2 to the cell addressed by row address #7 in the fifth bank 550 is completed, the memory control unit 57 changes the back image data D2 write destination to the sixth bank 560.

When the write address of the front image data D1 changes to the second bank 520 and the write address of the back image data D2 changes to the sixth bank 560, the memory control unit 57 sequentially reads the front image data D1 stored from the area specified by row address #0 to the area specified by row address #3 in the first bank 510. The memory control unit 57 also sequentially reads the first correction data (white reference data and black reference data) stored from the area specified by row address #22 to the area specified by row address #23 in the fifth bank 550. The correction processing unit 58 of the image controller 55 applies shading correction using the read first correction data to the read front image data D1, and sends the corrected front image data D1 to the personal computer 12.

As described above, each of the eight memory banks stores the same first correction data and second correction data in this embodiment of the invention. The memory control unit 57 can therefore read the first correction data and second correction data regardless of which of the eight banks is selected. More specifically, the memory control unit 57 can read the first correction data for correcting the shading of the front image data D1 from the seventh bank 570, for example, and can read the second correction data for correcting the shading of the back image data D2 from the first bank 510. In this embodiment of the invention the memory control unit 57 selects the bank from which the correction data is to be read according to specific rules from among the banks to which the image data D1 and D2 is not written and image data is not read. The method of selecting the bank from which this correction data is read is described below.

As shown in FIG. 12, when writing the front image data D1 to the area specified by row address #7 in the second bank 520 is completed, the memory control unit 57 starts writing the front image data D1 to the third bank 530. Likewise, when writing the back image data D2 to the area addressed by row address #7 in the sixth bank 560 is completed, the memory control unit 57 starts writing the back image data D2 to the seventh bank 570.

The memory control unit 57 sequentially reads the front image data D1 stored in the second bank 520 from the area specified by row address #0 to the area specified by row address #3 when the following two conditions are satisfied:

(1) reading the front image data D1 stored from the area specified by row address #0 to the area specified by row address #3 in the first bank 510 is completed; and

(2) the write destination of the front image data D1 has changed from the second bank 520 to the third bank 530.

Furthermore, the memory control unit 57 sequentially reads first correction data stored from the area specified by row address #22 to the area specified by row address #23 when the following condition is satisfied:

(3) the write destination of the back image data D2 has changed from the sixth bank 560 to the seventh bank 570.

The correction processing unit 58 applies a shading correction process to the read front image data D1 using the read first correction data, and sends the corrected front image data D1 to the personal computer 12. Here and below, the memory control unit 57 writes the front image data D1 and back image data D2, and reads the front image data D1 and correction data, by time shared memory access. Note that in this embodiment of the invention reading the back image data D2 and second correction data occur after reading the front image data D1 is completed through an area specified by a particular row address.

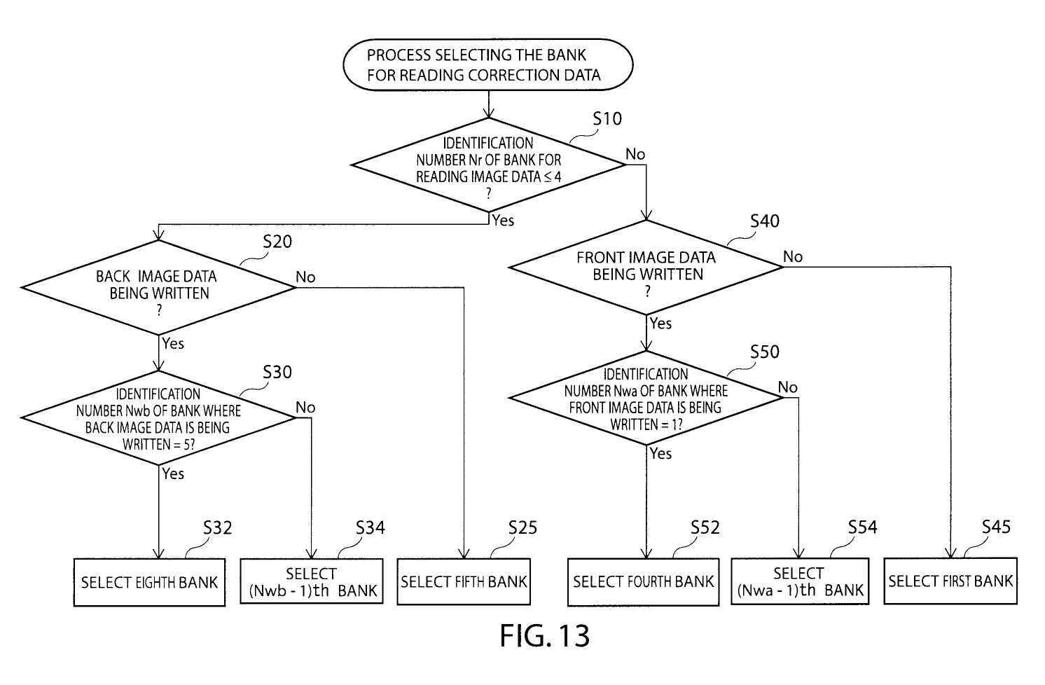

FIG. 13 is a flow chart of the process that selects the bank from which to read the correction data.

In step S10, the memory control unit 57 determines if the identification number Nr of the bank from which image data is read is 4 or less. The bank identification number is a number assigned to each bank, and in this embodiment of the invention the identification number of the first bank 510 is 1, and the identification number of the fifth bank 550 is 5. More specifically, the memory control unit 57 determines in step S10 if front image data D1 stored in any of the first bank 510 to the fourth bank 540 is being read, or if the back image data D2 stored in any of the fifth bank 550 to eighth bank 580 is being read.

If in step S10 the memory control unit 57 determines that the identification number Nr of the bank from which image data is read is 4 or less (step S10 returns Yes), that is, that front image data D1 is being read, the memory control unit 57 determines in step S20 if back image data D2 is being written.

If in step S20 the memory control unit 57 determines the back image data D2 is not being written (step S20 returns No), in step S25 the memory control unit 57 selects the fifth bank 550 for reading the first correction data.

If in step S20 the memory control unit 57 determines the back image data D2 is being written (step S20 returns Yes), the memory control unit 57 determines in step S30 if the identification number Nwb of the bank for writing the back image data D2 is 5.

If in step S30 the memory control unit 57 determines the identification number Nwb of the bank to which the back image data D2 is being written is 5 (step S30 returns Yes), in step S32 the memory control unit 57 selects the eighth bank 580 for reading the first correction data.

If in step S30 the memory control unit 57 determines the identification number Nwb of the bank for writing the back image data D2 is not 5 (step S30 returns No), in step S34 the memory control unit 57 selects bank (Nwb-1) for reading the first correction data. That is, the memory control unit 57 selects the bank with an identification number 1 less than the identification number of the bank to which the back image data D2 is being written.

If in step S10 the memory control unit 57 determines that the identification number Nr of the bank from which image data is read is not 4 or less (step S10 returns No), that is, that back image data D2 is being read, the memory control unit 57 determines in step S40 if front image data D1 is being written.

If in step S40 the memory control unit 57 determines the front image data D1 is not being written (step S40 returns No), in step S45 the memory control unit 57 selects the first bank 510 for reading the second correction data.

If in step S40 the memory control unit 57 determines the front image data D1 is being written (step S40 returns Yes), the memory control unit 57 determines in step S50 if the identification number Nwa of the bank for writing the front image data D1 is 1.

If in step S50 the memory control unit 57 determines the identification number Nwa of the bank for writing the front image data D1 is 1 (step S50 returns Yes), in step S52 the memory control unit 57 selects the fourth bank 540 for reading the second correction data.

If in step S50 the memory control unit 57 determines the identification number Nwa of the bank for writing the front image data D1 is not 1 (step S50 returns No), in step S54 the memory control unit 57 selects bank (Nwa-1) for reading the second correction data. That is, the memory control unit 57 selects the bank with an identification number 1 less than the identification number of the bank to which the front image data D1 is being written.

If the bank from which the correction data is read is selected according to such a rule, writing the image data D1 and D2, reading the front image data D1, and reading the first correction data can be done by accessing different banks. Likewise, writing image data D1 and D2, reading the back image data D2, and reading the second correction data can be done by accessing different banks. Note that in this embodiment of the invention as described above, the back image data D2 and second correction data are read after reading the front image data D1 is completed to an area specified by a particular row address.

As described above, the bank to which image data is written changes sequentially, and image data is read from a bank different from the bank used for writing. In addition, the correction data is read in this embodiment of the invention from a bank that is different from the bank to which image data is written and the bank from which image data is read.

This embodiment of the invention can therefore suppress the occurrence of time shared access (write processes and read processes) of areas specified by different row addresses in the same bank. Because time shared access to areas specified by different row addresses in the same bank can be suppressed, precharges can be suppressed, and the data transfer rate of the memory 500 can be improved.

Furthermore, because the data transfer rate of the memory 500 can be kept uniform, the capacity of the memory 500 used to temporarily store image data can be reduced. In addition, because reading and writing image data and reading the correction data occur according to a predetermined procedure with this embodiment of the invention, the memory control unit 57 does not need to execute a complicated control process to manage the addresses accessed in memory 500, and faster processing is thereby enabled.

### B. Variations

It will be obvious to one with ordinary skill in the related art that the invention is not limited to the foregoing embodiment and can be varied in many ways without departing from the scope of the accompanying claims. Some examples of such variations are described below.

B1: Variation 1

The invention is applied to a hybrid device combining a scanner and a printer in the embodiment described above, but the invention can also be applied in a scanner that does not have a printer function, a hybrid device that also has a fax function, and other types of devices that can read, scan, or capture images in other ways.

B2: Variation 2

SDRAM is used as the memory 500 in the embodiment described above, but the invention can obviously also be applied to image capture devices having a plurality of memory banks, including DDR2SDRAM (Double-Data-Rate2 Synchronous Dynamic Random Access Memory) and DDR3SDRAM (Double-Data-Rate3 Synchronous Dynamic Random Access Memory).

B3: Variation 3

The hybrid device 11 in the foregoing embodiment has two image reading sensors 33 and 34, but the invention can also be applied to hybrid devices having only one image reading sensor and to hybrid devices having three or more image reading sensors. Furthermore, a CIS type image reading sensor is used as the image reading sensor in the embodiment described above, but CCD (charge-coupled device) type image reading sensors may be used instead.

B4: Variation 4

The memory control unit 57 reads the back image data D2 after reading the front image data D1 is completed through an area specified by a particular row address in the embodiment described above, but the memory control unit 57 could read the back image data D2 while reading the front image data D1. Precharges can be minimized and the data transfer rate of the memory 500 can be increased in this configuration if different banks are used for writing and reading the image data D1 and D2 and reading the correction data.

B5: Variation 5

Image data is always read from a different bank than the bank used for writing in the embodiment described above, but the image data could be read from a desirable area specified by the CPU 53. As a result, even if image data is written and image data is read using the same bank, the image data will not written to and read from the same bank for a long time because the bank to which the image data is written changes sequentially in this configuration. Time shared access (writing process and read process) to areas specified by different row addresses in the same bank can therefore be minimized, and the memory 500 transfer rate can be improved.

B6: Variation 6

The bank accessed for writing changes sequentially to the next bank each time writing is completed to an area specified by four row addresses in the embodiment described above, but the bank accessed for writing may be changed sequentially to the next bank each time writing data for a specific number of lines in the captured image is completed.

Furthermore, the memory control unit 57 in the foregoing embodiment changes the bank accessed for writing when writing a specific amount of data is completed, but the memory control unit 57 may instead change the bank addressed for writing when writing a desired amount of data specified by the CPU 53 is completed. However, if the write bank is changed when writing a specific amount of data is completed as in the foregoing embodiment, image data can be stored in each bank according to a predetermined rule without requiring complicated control.

B7: Variation 7

In the foregoing embodiment the memory control unit 57 changes the bank to which image data is written according to a predetermined sequence, but a configuration in which the memory control unit 57 freely selects the bank for writing the image data is also conceivable. Because the bank to which image data is written also changes in such a configuration, image data will not be written to and read from the same bank for an extended time. However, if the memory control unit 57 changes the bank accessed for writing image data according to a predetermined order as described in the foregoing embodiment, image data can be stored in each bank in an orderly sequence. In addition, the bank accessed for reading and the bank accessed for writing can be different banks as a result of the memory control unit 57 selecting the bank for reading the image data according to a predetermined sequence.

B8: Variation 8

The memory 500 in the foregoing embodiment has eight banks, but the number of banks is not limited to 8. More specifically, the number of banks can be any number that enables changing the bank accessed for writing. For example, if the image reading device captures only the front image data D1 and does not apply a correction process using correction data, the memory 500 may be formed with two or more banks.

B9: Variation 9

Some of the functions performed by software in the foregoing embodiment may be performed by hardware, and some of the functions performed by hardware in the foregoing may be performed by software.

The method of the present invention and variations thereof disclosed herein can be implemented using non-transitory computer-readable media for carrying or having computer-executable instructions or data structures stored thereon. Such computer-readable media can be any available media that can be accessed by a processor of a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store program code in the form of computer-executable instructions or data structures and that can be accessed by a processor (e.g. a central processing unit such as CPU 53) of a general purpose or special purpose computer and thereby executed by the computer to perform the method of the present invention. Combinations of the above should also be included within the scope of computer-readable media.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. An image reading device comprising:
an image reading sensor that captures an image of a subject;
memory that has a storage area divided into a plurality of banks, each of the plurality of banks having an image data storage area with a data capacity for storing image data of the captured image; and
a memory control unit that writes a portion of the image data to the image data storage area of an accessed bank and then changes the bank accessed for writing a subsequent portion of the image data so that the image data is stored in the plurality of banks segmented into data units that are smaller than the data capacity of an image data storage area.

2. The image reading device described in claim 1, wherein:
the memory control unit reads a portion of the image data from a bank that is different from the bank to which a different portion of the image data has just been written.

3. The image reading device described in claim 1, wherein:
the memory control unit changes the bank accessed for writing after completing writing a particular amount of image data that is less than the data capacity of the image data storage area.

4. The image reading device described in claim 3, wherein:
the particular amount of image data is four rows of image data.

5. The image reading device described in claim 1, wherein:
the memory control unit changes the bank accessed for writing according to a predetermined order.

6. The image reading device described in claim 5, wherein:
the predetermined order is sequential from a first bank to a last bank and then back to the first bank.

7. A method of writing image data in an image reading device,
the image reading device having memory with a storage area divided into a plurality of banks, and each of the plurality of banks having an image data storage area with a data capacity for storing the image data,
the image data writing method comprising:
(a) capturing an image of a subject; and
(b) writing a portion of the image data to the memory by accessing a bank and then changing the bank accessed for writing a subsequent portion of the image data so that the image data of the captured image is segmented into data units that are smaller than the data capacity of an image data storage area and the data units are sequentially stored in the banks.

8. A tangible computer-readable medium containing a program of instructions executable by a computer processing unit to write image data representing a captured image of a subject in an image reading device, the image reading device having memory with a storage area divided into a plurality of banks, and each of the plurality of banks having an image data storage area with a data capacity for storing the image data, whereby the computer processing unit executes the program of instructions to:
write a portion of the image data to the memory by accessing a bank and then changing the bank accessed for writing a subsequent portion of the image data so that the image data of the captured image is segmented into data units that are smaller than the data capacity of an image data storage area and the data units are sequentially stored in the banks.
